(19) United States
(12) Patent Application Publication
(10) Pub. No.: US 2006/0224395 A1
(43) Pub. Date: Oct. 5, 2006

(54) Program for generating user-compatible business application data, recording medium containing the program, and user-compatible business application

(76) Inventor: Isao Miyadai, Tokyo (JP)

Correspondence Address: DICKSTEIN SHAPIRO LLP, 1825 EYE STREET NW, Washington, DC, 20006-5403, US

(21) Appl. No.: 10/555,381

(22) PCT Filed: May 14, 2004
(86) PCT No.: PCT/JP04/06861

§ 371 Date: Nov. 2, 2005

(30) Foreign Application Priority Data
May 16, 2003 (JP) 2003-139598

(51) Int. Cl. G06Q 99/00; G05B 19/418; G06F 15/02

(52) U.S. Cl. 705/1; 705/8; 705/9

(57) ABSTRACT

A definition database contains stored definition data. With regard to each of a plurality of folders required by each of a plurality of application systems, the definition data defines how to generate the following from a report: data items, the type of report and range of dates thereof used in creating the folder, and the data of the folder data items. A report entered from an input terminal is stored in a report database. A report of the type and range of dates that are in accordance with the definition data is extracted from among reports that have been stored in the database. On the basis of the data relating to the report extracted, the plurality of folders are created in accordance with a definition, which is contained in the definition data, specifying how to generate the data of the folder data items from the report.

### BACKGROUND OF THE INVENTION

1. Field of the Invention

This invention relates to a program for generating user-compatible business application data, a recording medium on which the program has been recorded, and a system and method for generating user-compatible business application data. More particularly, the invention relates to a program for generating business application data (a folder) in a form required by an application system based upon input data (a report) in a form conforming to the user, a recording medium on which the program has been recorded, and a system and method for generating the data.

2. Description of the Related Art

In corporations and other enterprises, computers are used to execute a variety of business-related processing such as processing for computing salaries, processing for reimbursing travel expenses, processing for projecting sales and processing for managing sales. Often a computer system (application system) for business processing is provided for each type of business processing. In order to operate each application system, it is necessary for data required by each application system to be input to the application system at a timing required by the application system in a format required by the application system.

In an automobile insurance cost estimating support system described in the specification of Japanese Patent Application Laid-Open No. 2001-350926, the mail address of a mobile telephone, the name of the automobile manufacturer and the automobile name (these constitute primary information) are input using a personal computer and the entered primary information is stored in a server together with an identification number. Furthermore, automobile inspection information is input using the mobile telephone, and the entered automobile inspection information (secondary information) is sent to the server together with the identification number. The server combines the primary and secondary information and stores the combined information in a database. The cost of automobile insurance is estimated using the automobile manufacturer name and automobile name from the primary information stored in the database and the automobile inspection information of the secondary information stored in the database.

In the case of the example set forth above, data required by the automobile insurance cost estimating support system is automobile manufacturer name, automobile name and automobile inspection information. The data required by the automobile insurance cost estimating support system, which is the application system, is input from a plurality of terminal devices, namely personal computers and mobile telephones.

In corporations and other enterprises, the employees use input terminal devices (mainly personal computers) to enter records or reports of actions or activities on an individual- or group-basis, examples of this information being punch-in time, punch-out time, business reports and business-trip reports. The format and content of these records or reports of actions or activities on an individual- or group-basis are determined from a standpoint suited to the records or reports of actions or activities of employees of enterprises, etc. On the other hand, as mentioned above, data required by an application system must be input to the application system at a timing required by the application system and in a format required by the application system. Consequently, even if records or reports of actions or activities of employees on an individual- or group-basis are input by the employees from input terminal devices, they cannot be processed as is in the application system. As seen typically in the system described in the above-cited reference, the state of the art is such that data required by an application system is re-entered at the timing required by the application system and in the format required by the application system.

### SUMMARY OF THE INVENTION

Accordingly, an object of the present invention is to so arrange it that when an employee (user) of an enterprise or the like has entered data (a report) representing a record or report of actions or activities on an individual- or group-basis from an input terminal device in a form conforming to the record or report, the data can be utilized by an application system and re-entry of the data in the application system can be eliminated to the maximum extent.

Another object of the present invention is to so arrange it that data entered by an employee or the like can be shared in application systems of a plurality of types.

A further object of the present invention is to so arrange it that it is not always necessary for the timing of data entry by an employee or the like to be made to conform to the operation timing of an application system.

Yet another object of the present invention is to so arrange it that data whose entry has not been completed (so-called “undelivered data”) is monitored regardless of the fact that entry of the data should have been completed by an employee or the like, and entry of data is requested if undelivered data exists.

According to the present invention, the foregoing objects are attained by providing a method of generating user-compatible business application data, the method generating a folder for input to an application system and to be applied to the application system at a timing that satisfies a requirement of the application system, the folder having data items and a format required by the application system in order for business processing to be executed by the application system, the folder being generated from an input report having data items and a format that reflect activities of a user and being created at a timing that reflects the activities of the user. In terms of data items, format and input timing, the input report is independent of those required by the application system. The method comprises the steps of: entering an input report, which is accompanied by time-related data, together with an identification code thereof to a generating system, the input report including data regarding one or a plurality of items and having a format suitable for expressing results of user activities; storing the entered input report together with the identification code thereof in a database of the generating system in order to make the input report available for use in one or a plurality of application systems; and generating a folder, which includes data required by the application system in a format required by the application system, at a given timing prior to start of business processing in the application system, by selection or manipulation of an input report that has been stored in the database and of data contained in the input report without executing the business processing, and delivering the generated folder to the application system.

The user is an individual who enters data from an input terminal. The user is capable of entering data, which is related to a record or report of his or her own actions or activities, from an input terminal in a form (format and data items) suited to the creation (input) of this record or report. This means that the data is user-compatible. The data [data expressing one record (written) or one report (written)] relating to the record or report entered from the input terminal is referred to as an “input report”. In contradistinction, data in a form required by the application system is referred to as a “folder”. One application system requires one or a plurality of folders in order to execute business processing. The data that is the content of the folder is business application data.

The data items, format and input timing of the input report entered by the user using the input terminal are independent of those required by the application system. That is, the data items, format and input timing of the input report are decided without being influenced by the requirements of the application system. The data items, format and input timing of the input report can be decided from the standpoint of the activities of the user without making these match the requirements of the application system.

The input report is input to the generating system together with the identification code thereof. In a case where there are reports of a plurality of types, a type code is appended to every type of report. In a case where there are a plurality of reports of one type, codes for identifying these plurality of reports are appended as necessary. An identification code may be the name of the creator of the report, the date (date and time) of creation, etc. If necessary, a report may be accompanied by data representing the name of the creator, the post of the creator in the enterprise to which the creator belongs, etc.

A folder includes one or a plurality of data items. In a case where there are folders of a plurality of types, a type code is appended to every type of folder. In a case where there are a plurality of folders of one type, codes for identifying these plurality of folders are appended as necessary.

An input report is stored in a database of the generating system. The entry (acceptance) of an input report and the storing of the input report in the database can be performed in a variety of ways, which include storing the input report upon entering it from an input unit of a computer, storing the input report upon reading it by a data reader of a computer, and storing the input report upon receiving it over a network.

A folder in which data required by the application system is contained in a format required by the application system is generated using an input report that has been stored in the database.

The generation of a folder is performed at a given timing prior to start of business processing in the application system. The given timing may be a timing that is in accordance with an externally applied command, a timing specified in the application system or a predetermined time (or date).

In any case, a folder is generated in the generating system prior to the start of business processing without business processing being executed.

A folder is generated by selection or manipulation of a report, which has been stored in the database, and of the data contained in the input report.

Since a report is input to the generating system and stored in the database together with the identification code thereof, a report necessary for generating a folder can be selected from the database based upon the identification code accompanying the report.

Not only can a report be selected but it is also possible to select data from the report. In a case where a report of one type contains data of a plurality of data items, some of the data in the report can be used to generate a folder of one type. Of course, by using one part of the data in a report to generate a folder of one type and using other data (which may include the one part of the data mentioned above) in the same report to generate a folder of another type, folders of a plurality of types can be generated from a report of one type (i.e., the report data can be disassembled). Further, the data of a specific data item contained in a report of one type can also be used as common data for generating folders of a plurality of types (i.e., the report data can be shared). It is also possible to create a folder of one type using reports of a plurality of types. In such case a folder is generated and contains data of one or a plurality of data items included in a report of one type and data of one or a plurality of data types included in a report of another type (i.e., report data can be combined). Data obtained by subjecting data in a report to manipulation (four-rule processing utilizing data of a specific data item in a report and data of another specific item in the report, processing for further four-rule operations using a prescribed value and the data obtained by the four-rule processing, etc.) can also be adopted as the data of a folder.

A folder generated includes data, which is required by the application system, in a format required by the application system. If necessary, a folder possessing data of a format required by the application system is generated by executing processing such as a conversion of data format.

The application system implements a business application based upon the folder it has been given. There are instances where a folder of one type is generated with respect to one application system, and there are instances where folders of a plurality of types are generated in a case where it is required by the application system. The method of generating user-compatible business application data according to the present invention generate a folder for one application system and generate a folder for a plurality of application systems.

In accordance with the present invention, an input report and a folder applied to an application system exist independently of each other. For example, an input report is positioned as a record or report of actions and activities of users (such as the employees of an enterprise) as individuals or groups, and even if the data of an input report cannot be used as a folder to be applied as is to an application system, a folder that includes the data required by the application system in a format required by the application system is generated from the input report. This means that it is unnecessary for the user to be aware of the folder that is to be applied to the application system and to input data in conformity with the requirements of the application system (i.e., it is unnecessary for the user to create the input report). The user is capable of entering data from the standpoint of creating an input report as a record or report of the actions or activities of the user.

Further, since the input report and folder are independent of each other, the relationship between the terminal used to enter the input report and the application system is not fixed. It is unnecessary to alter, reorganize or establish an application system in conformity with the report input terminal, and therefore an existing application system can be utilized effectively.

Further, in accordance with the present invention, once input reports have been stored in the database, an input report necessary for generating a folder and the data contained in this input report can subsequently be selected or manipulated at a given timing prior to the start of business processing in the application system, thereby generating the folder. That is, it is unnecessary to enter an input report in conformity with the time at which the application system executes processing. Although it is desired that this be performed prior to the time at which processing is executed by the application system, the input report can be entered at any time. The task of entering data, which is required by an application system, separately of entry of an input report at a timing required by the application system and in a format required by the application system can, in principle, be eliminated. This makes it possible to alleviate the task of entering data.

In one embodiment, an input folder is generated by selection or manipulation of an input report, which has been stored in the database, and of data contained in the input report in accordance with a folder generating definition that specifies how the folder is generated from the input report. A folder to be delivered to the application system can be generated by selecting or manipulating an input report, which has been stored in a database, and the data in the report in accordance with a folder generating definition.

It may be so arranged that an input report to be used in generating the folder is selected from among input reports, which have been stored in the database, in accordance with a definition for selecting a report to be used in generating the folder, and the folder is generated by selection or manipulation of data in the selected report in accordance with a folder generating definition that specifies how the folder is generated from the input report.

A report selecting definition for selecting an input report to be used in generating a folder can be made to include the following definitions:

The first is a report interval definition that specifies the interval of a report to be used in generating a folder. In accordance with the report interval definition that specifies the interval of a report to be used in generating a folder, an input report that falls within an interval to be used in generating the folder is selected based upon time-related data accompanying an input report that has been stored in the database. The interval of a report used in generating a folder includes an instant in time, a length of time (a range of times), a day (a range of dates) or a month (a range of months).

The second is a report-type definition that specifies the type of a report to be used in generating a folder. In this case, the identification code of the input report includes a code identifying the type of input report. In accordance with a report-type definition that specifies the type of a report to be used in generating the folder, an input report of the type to be used in generating the folder is selected based upon the identification code of the input report that has been stored in the database.

The third is a report item definition that specifies a data item that is to be included in a report to be used in generating the folder. In accordance with a report item definition that specifies a data item to be included in a report to be used in generating the folder, an input report to be used in generating the folder is selected based upon the data item included in the input report that has been stored in the database.

The fourth is a data value definition that specifies a data value that is to be included in a report to be used in generating the folder. In accordance with a data value definition to be included in a report to be used in generating the folder, an input report to be used in generating the folder is selected based upon the data value included in an input report that has been stored in the database. The data value includes the name of the creator of an input report, the post to which the creator belongs, the region to which the post belongs and a data attribute, etc.

It may be so arranged that a report that has been selected by a combination of any two or more of the above-mentioned four selection methods is used in generating a folder. For example, in a case where a report, among reports of a specific type, having time-related data that falls in a specific interval is used in generating a folder, selection of the report is performed based upon the report-type definition and report interval definition. In a case where a report, among reports of a specific type, having a specific data value is used in generating a folder, selection of the report is performed based upon the report-type definition and data value definition. In either case, a folder delivered to the application system is generated by selection or manipulation of data contained in the selected report.

According to the present invention, the foregoing object is attained by providing a program for generating user-compatible business application data and a recording medium on which the program has been recorded. The recording medium includes a semiconductor storage device, a magnetic recording medium, an optical recording medium, a magneto-optic recording medium and other portable or stationary recording media.

A program for generating user-compatible business application data is positioned as a program, or so-called middleware, intermediate a basic program such as an operating system program (OS) and an application program such as a program for executing business processing in an application system.

A program for generating user-compatible business application data according to the present invention comprises computer code for implementing the steps of: accepting entry of an input report, which is accompanied by time-related data, together with an identification code thereof to a generating system, the input report including data regarding one or a plurality of items and having a format suitable for expressing results of user activities; storing the entered input report together with the identification code thereof in a database of the generating system in order to make the input report available for use in one or a plurality of application systems; and controlling the generating system so as to generate a folder, which includes data required by the application system in a format required by the application system, at a given timing prior to start of business processing in the application system, by selection or manipulation of an input report that has been stored in the database and of data contained in the input report without executing the business processing, and deliver the generated folder to the application system.

Further, according to the present invention, the foregoing object is attained by providing a system for generating user-compatible business application data. The system for generating user-compatible business application data according to the present invention comprises: input report accepting means for accepting entry of an input report, which is accompanied by time-related data, together with an identification code thereof, the input report including data regarding one or a plurality of items and having a format suitable for expressing results of user activities; database control means for controlling a database so as to store the input report, which has been accepted by the input report accepting means, together with the identification code thereof in the database in order to make the input report available for use in one or a plurality of application systems; and folder generating/delivering means for generating a folder, which includes data required by the application system in a format required by the application system, at a given timing prior to start of business processing in the application system, by selection or manipulation of an input report that has been stored in the database and data contained in the input report without executing the business processing, and delivering the generated folder to the application system.

A representative program for generating user-compatible business application data according to the present invention is as follows: Specifically, the program for generating user-compatible business application data comprises a definition accepting program for controlling a computer so as to accept, and store in definition data storage means with regard to a folder to be applied to an application system, a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report; a report accepting program for controlling the computer so as to accept, and store in report data storage means, a report having time data, a report-type code and data of one or a plurality of report data items; a report selecting program for controlling the computer so as to select, from among reports stored in the report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and a folder data generating program for controlling the computer based upon data relating to the selected report so as to generate data of a data item of a folder, which has been specified by the folder data-item definition, in accordance with the folder data generating definition.

The present invention can also be defined as follows: Specifically a program for generating user-compatible business application data according to the present invention causes a computer to function as: definition data storage means for storing definition data that includes, with regard to a folder to be applied to an application system, a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report; report storage means for storing a report having time data, a report-type code and data of one or a plurality of report data items; report selecting means for selecting, from among reports stored in the report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and folder data generating means for generating data of a data item of a folder, which has been specified by the folder data-item definition, in accordance with the folder data generating definition based upon data relating to the report by the report selecting means.

A folder data-item definition, report selecting definition and folder data generating definition are stored in definition data storage means (a definition data storage device). The storing of the folder data-item definition, report selecting definition and folder data generating definition in the definition data storage means can be performed in a variety of ways, which include storing the definition upon entering it from an input unit of a computer, storing the definition upon reading it by a data reader of a computer, and storing the definition upon receiving it over a network. As will be described next, a program according to the present invention controls a computer so as to generate data of a data item of a folder to be applied to an application system, based upon a folder data-item definition, report selecting definition and folder data generating definition stored in definition data storage means. The definition accepting program, report accepting program, report selecting program and folder data generating program, as well as a later-described start program, report requesting program and program for generating user-compatible business application data may be independent programs for implementing respective of these functions or program portions (routines) for implementing specific functions of one program.

A report is stored in report storage means (a report storage device). The storing of a report in the report storage means also can be performed in a variety of ways, which include storing the report upon entering it from an input unit of a computer, storing the report upon reading it by a data reader of a computer, and storing the report upon receiving it over a network.

A report stored in the report storage means possesses time data, a report-type code and data of one or a plurality of report data items. Time represented by time data includes the concept of date (day, month and year), time (hour, minute and second), quarter (spring quarter, summer quarter, autumn quarter and winter quarter), half (first half and second half) and other times.

Time data may be one item of data of a data item in a report or may be appended to a report separately. A date and time, etc., entered by the user using a terminal (report input terminal) for entering a report may be used as time data possessed by a report, or may be based upon a timekeeping unit with which the report input terminal is equipped. The date and time, etc., at the moment of storage in the report storage means may be a date or time, etc., possessed by a report. In any case, each report stored in the report storage means has time data.

The generation of data of a data item of a folder is performed based upon data relating to a report, which is stored in the report storage means, having time data, a report-type code and data or one or a plurality of report data items. A data item of a folder and a data item of a report may be the same or different. In any case, owing to generation of data of a data item of a folder, a folder having data of a data item to be applied to an application system is created. Data relating to a report includes not only data in the report but also data relating to the existence of the report.

In the creation of a folder, reference is had to a folder data-item definition, report selecting definition and folder data generating definition stored in definition data storage means.

From among reports stored in the report storage means, a report in line with any one condition is selected from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition.

The interval of a report specified by the report selecting definition signifies the closing period (terminal point) of a folder to be applied to an application system, e.g., a range conforming to a closing date, a closing time, a closing quarter and a closing half (namely a range of dates, a range of times, a range corresponding to a quarter and a range corresponding to a half). By way of example, if the close for creation of a folder to be applied to an application system is the 20^{th} day of every month, then the interval specified by a report selecting definition regarding this folder to be applied to the application system will be a range from the 21^{st} day of the previous month to the 20^{th} day of the present month. If the close for creation of a folder to be applied to an application system is a time that is every two hours (e.g., 10:00, 12:00, 14:00), then the intervals specified by a report selecting definition regarding this folder to be applied to the application system will be the following ranges of times: 8:00 to 10:00, 10:00 to 12:00, 12:00 to 14:00.

The interval of a report to be used in creating a folder may also be decided by the day of the week. For example, if the close for creation of a folder to be applied to an application system is Friday of every week, then the interval specified by a report selecting definition regarding this folder to be applied to the application system will be a range of dates corresponding to Saturday of the previous week to Friday of the present week.

Further, reports stored in the report storage means have respective ones of report-type codes. Based upon the report-type code possessed by a report, therefore, a report of the type defined in the report selecting definition can be selected as a report to be used in creating a folder. The report-type code may be one item of data of a data item of a report or may be appended to the report separately of the data of the data item.

Furthermore, reports stored in the report storage means have respective ones of data of report data items. Based upon data of a report data item possessed by a report, therefore, a report having data of a report data item defined in the report selecting definition can be selected as a report to be used in creating a folder.

It may arranged so as to include a data value (the position to which the creator of the report belongs, the region to which the post belongs, the name of the creator of the report and an attribute of the data value, etc.), which is to be included in a report to be used in creating a folder, in the report selecting definition, and select a report in line with at least one condition from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition. Further, it may be so arranged that a report in line with all of these conditions is selected.

Based upon data relating to a selected report, data of a data item of the folder is generated in accordance with the folder data generating definition that has been stored in the definition data storage means.

A folder data generating definition that specifies how data of a data item of a folder is generated includes one or a plurality of any of the following (i) to (iii):

(i) A definition that specifies that the data of a data item in the report is data of a corresponding data item of a folder.

(ii) A definition that specifies that data, which is obtained by applying prescribed processing to data of one or a plurality of data items in the report, is data of a data item of the folder. Examples of the prescribed processing are four-rule processing utilizing data of a specific data item in a report and data of another specific item in the report, processing for further four-rule operations using a prescribed value and the data obtained by the four-rule processing, etc.

(iii) A definition that specifies that the number of reports selected is data of a data item of the folder.

In any case, in accordance with data relating to a selected report, data of a data item of a folder specified in a folder data-item definition is generated (decided) based upon the folder data generating definition.

A folder having generated data is applied to an application system. It may be so arranged that processing such as a data format conversion is applied to data of a data item of a generated folder and a folder having data obtained by execution of processing such as the data format conversion is applied to an application system. The application system executes a business application based upon the folder provided. A folder of one type may be created with respect to one application system, and there are also instances where folders of a plurality of types are created in a case where this is required by the application system. The program for generating user-compatible business application data according to the present invention may be one for creating a folder for one application system or one for creating a folder for a plurality of application systems.

In accordance with the present invention, a report and a folder that is applied to an application system exist independently of each other. For example, a report is positioned as a record or report of actions or activities of users (such as the employees of an enterprise) as individuals or groups, and even if the data of the report cannot be used as a folder to be applied as is to an application system, a folder that possesses the data of a data item required by the application system is created based upon report-related data in accordance with a folder data generating definition stored in definition data storage means. This means that it is unnecessary for the user to be aware of the folder that is to be applied to the application system and to input data in conformity with the requirements of the application system (i.e., it is unnecessary for the user to create the report). The user is capable of entering data from the standpoint of creating a report as a record or report of the actions or activities of the user.

Further, since the input report and folder are independent of each other, the relationship between the terminal used to enter the report and the application system is not fixed. For example, assume that a new, user-friendly input terminal has been developed. If it is decided how to generate a folder from a report that is entered from the new report input terminal, even a new report input terminal can be used to create a folder to be applied to an application system. It is unnecessary to alter, reorganize or establish an application system in conformity with the report input terminal, and therefore an existing application system can be utilized effectively.

Further, in accordance with the present invention, once reports have been stored (accumulated) in report storage means, a report necessary for creating a folder is subsequently selected and a folder is created based upon data relating to the selected report. That is, it is unnecessary to input a report in conformity with the time at which the application system executes processing. The report can be entered at any time if it is prior to execution of processing by the application system. The task of entering data, which is required by an application system, separately of entry of a report at a timing required by the application system and in a format required by the application system can, in principle, be eliminated. This makes it possible to alleviate the task of entering data.

In one embodiment, the folder data-item definition specifies a plurality of data items included in one folder. In this case, the folder data generating definition specifies how each item of data of the plurality of data items included in the folder is generated from data relating to a report.

Preferably, in a case where folders of a plurality of types are necessary, the definition accepting program controls a computer in such a manner that a folder data-item definition, report selecting definition and folder data generating definition are stored in data storage means with regard to each of the folders of the plurality of types. Folder of a plurality of types to be applied to one or a plurality of application systems can be created.

In accordance with the present invention, it is also possible to create folders of a plurality of types using a report (or plurality of reports) of one type. For example, in a case where a report of one type contains data of a plurality of data types, by using one part of the data in a report of one type to create a folder of one type and using other data (which may include the one part of the data mentioned above) in the same report to create a folder of another type, folders of a plurality of types can be generated from a report of one type (i.e., the report data can be disassembled). Further, the data of a specific data item contained in a report of one type can also be used as common data for creating folders of a plurality of types (i.e., the report data can be shared). Since it is no longer necessary to input the same data to one or a plurality of application systems, the data input operation is simplified.

Of course, it is also possible to create a folder of one type using reports of a plurality of types. In this case, a folder is created and contains data of one or a plurality of data items included in a report of one type and data of one or a plurality of data types included in a report of another type (i.e., report data can be combined).

In a preferred embodiment, the data accepting program controls a computer in such a manner that a folder-data generating trigger definition, which specifies timing for generating data of a data item of a folder to be applied to an application system, is further stored in the definition data storage means. In this case, there is further provided a start program for controlling a computer so as to start the report selecting program and folder data generating program at a timing that has been specified in the folder-data generating trigger definition. Timing defined in the folder-data generating trigger definition also includes the concept of date (day, month and year), time (hour, minute and second), quarter (spring quarter, summer quarter, autumn quarter and winter quarter), half (first half and second half) and other times. A report is selected from report storage means at a timing specified in the folder-data generating trigger definition and a folder is created based upon data relating to the report selected.

In another preferred embodiment, the definition accepting program controls a computer in such a manner that a report input deadline definition that specifies an input deadline of a report to be stored in the report storage means is further stored in the definition data storage means. In this case, there is provided a report requesting program for controlling a computer in such a manner that at a timing earlier than a timing specified in the folder-data generating trigger definition, it is determined whether a report, which possesses time data that falls within an interval specified by the report selecting definition, a type specified by the report selecting definition or data of a report data item specified by the report selecting definition, has been stored in the report storage means by a deadline specified by the report input deadline definition, and if it is determined that the report has not been stored in the report storage means by the deadline specified by the report input deadline definition, data representing the fact that this report is to be stored in the report storage means is output.

For example, a report input deadline that specifies an input deadline of a report to be stored in report storage means is specified with regard to a report of this type, which is to be stored in the report storage means, periodically or regularly (e.g., daily, weekly, biweekly, etc.). If a report to be stored in report storage means periodically or regularly has not been stored in the report storage means periodically or regularly, it is judged that the report that should have been stored has not been stored. In this sense, the report input deadline definition can be construed as data that specifies a report that should have been stored in the report storage means. Since a report possesses time data, if the report is one that is to be entered every day, it is determined whether all reports possessing a date in the interval specified by the report selecting definition have been completed.

If a report to be used in creating a folder has not yet been stored in report storage means, the user can be requested to enter the report. For example, data representing the fact that a report that has not arrived is to be stored in the report storage means is output (transmitted) by e-mail, facsimile or other communication means, and the data is displayed on, e.g., an input terminal used by the user.

The present invention also provides a program for accepting definition data and storing it in definition data storage means. A definition accepting program according to the present invention controls a computer so as to accept, from an input unit, with regard to a folder to be applied to an application system, input of a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report, and so as to store the accepted folder data-item definition, report selecting definition and folder data generating defining in the definition data storage means.

Furthermore, the present invention also provides a program for causing a computer to execute processing for selecting a report to be used in creating a folder and processing for generating data of a data item of the folder. This program according to the present invention includes a report selecting program and a folder data generating program. The report selecting program controls a computer so as to select, from among reports stored in the report storage means having time data, report-type codes and data of one or a plurality of report data items, a report, which is in line with at least any one condition, from among a report in line with a condition that time data falls within an interval of a report to be used in creating a folder specified by the report selecting definition, a report in line with a condition that the report possesses a report-type code to be used in creating a folder specified by the report selecting definition, and a report in line with a condition that the report possesses data of a report data item to be used in creating a folder specified by the report selecting definition. The folder data generating program controls the computer based upon data relating to the selected report so as to generate data of a data item of a folder, which has been specified by the folder data-item definition, in accordance with a folder data generating definition that specifies how the data of the data item is generated from the data relating to the report.

In one embodiment, the report selecting program and the folder generating program included in the program that causes a computer to execute the processing for selecting a report to be used in creating a folder and the processing for generating data of a data item of the folder control a computer having definition data storage means for storing, with regard to a folder to be applied to an application system, a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report; and report storage means for storing a report having time data, a report-type code and data of one or a plurality of report data items.

One or a combination of some or all of the definition accepting program, report accepting program, report selecting program, folder data generating program, start program and report requesting program, which are parts of the above-described program for generating user-compatible business application data, are recorded on a recording medium and used upon being sold or are supplied via a network. The present invention also provides the recording medium containing the program.

The present invention further provides another system for generating user-compatible business application data. This system according to the present invention comprises: definition data storage means for storing, with regard to a folder to be applied to an application system, definition data that includes a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report; report storage means for storing a report having time data, a report-type code and data of one or a plurality of report data items; report selecting means for selecting, from among reports stored in the report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and folder data generating means for generating data of a data item of a folder, which has been specified by the folder data-item definition, in accordance with the folder data generating definition, based upon data relating to the report selected by report selecting means.

The present invention also provides a method suited to the above-described system for generating user-compatible business application data. Specifically, the method comprises the steps of: providing definition data storage means for storing, with regard to a folder to be applied to an application system, definition data that includes a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report, and report storage means for storing a report having time data, a report-type code and data of one or a plurality of report data items; selecting, from among reports stored in the report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and generating data of a data item of a folder, which has been specified by the folder data-item definition, in accordance with the folder data generating definition, based upon data relating to the selected report.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating the relationship among input terminals, reports, folders and application systems;

FIG. 2 is a processing block diagram representing processing in a host computer;

FIGS. 3a and 3b illustrate an example of a report definition and an example of a folder definition, respectively;

FIGS. 4a, 4b and 4c illustrate an example of an undelivered-report request definition, an example of a definition of how to generate data of a folder and an example of a definition for delivering a folder to an application system, respectively;

FIG. 5 is a flowchart illustrating the flow of main processing by a host computer;

FIG. 6 illustrates the relationship among input terminals, a host computer and application systems;

FIG. 7 is a diagram illustrating the content of a report database;

FIG. 8 is a diagram illustrating the manner in which a folder for a payroll system is created;

FIG. 9 is a diagram illustrating the manner in which a folder for a travel-expense reimbursement system is created;

FIG. 10 is a diagram illustrating the manner in which a folder for a sales projection system is created;

FIG. 11 is a diagram illustrating the manner in which a folder for a sales management system is created; and

FIG. 12 illustrates the intervals (closing dates) of reports used in creating a folder for a payroll system, a folder for a travel-expense reimbursement system, a folder for a sales prediction system and a folder for a sales management system.

### DESCRIPTION OF THE PREFERRED EMBODIMENTS

Employees of an enterprise or the like use input terminals to enter records or reports of actions or activities as individuals or groups as the occasion demands, daily or by a deadline, examples being punch-in time, punch-out time, business reports and business-trip reports. A set of data representing records or reports of actions or activities of employees of an enterprise as individuals or groups (namely a set of data that is entered by employees or the like using input terminals) shall be referred to as a “report”. The content (data items) of a report is stipulated in accordance with content such as the organization of the enterprise or the like, posts and activities, actions, business and jobs, etc., of employees.

On the other hand, an enterprise or the like has application systems (a computer system in which application system programs have been installed) in order to execute or assist the business of the enterprise (inclusive of business on the company- or organizational level). Examples of application systems are a payroll system, travel-expense reimbursement system, sales projection system and sales management system. These application systems require system-specific data. A set of data required by an application system shall be referred to as a “folder” in order to distinguish it from the above-mentioned report.

The report and the folder are clearly distinguished in the following description.

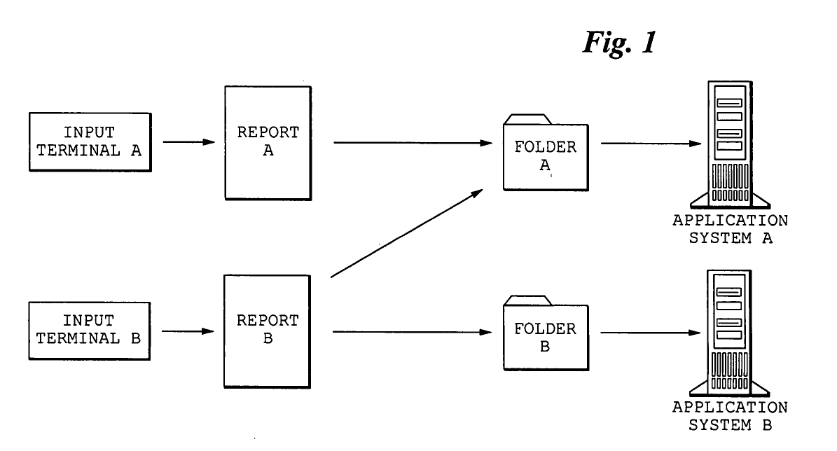

FIG. 1 illustrates an example of the relationship among input terminals for allowing employees, etc., of an enterprise or the like to enter reports, the entered reports, application systems for executing or assisting the business of the enterprise, and folders required by the application systems.

In the example shown in FIG. 1, a report A is entered (created) by an input terminal A, and a report B is entered (created) by an input terminal B. A folder A is created based upon data relating to two types of reports, namely report A and report B. A folder B is created based upon data relating to report B. Report B is used in creating both folders A and B. Folder A is applied to application system A, and folder B is applied to application system B. Application system A executes prescribed business processing based upon folder A applied thereto. Application system B executes prescribed business processing based upon folder B.

A report has its format and content (data items) specified from a standpoint conforming to records or reports of actions or activities of employees, etc., of an enterprise or the like. On the other hand, a folder must include neither too much nor too little data required by an application system in accordance with the business processing executed by the application system. Accordingly, even though it is possible that the content (data items and data) of a report and the content (data items and data) of a folder may partially overlap, they do not necessarily coincide and in many cases are different from each other.

A system for generating user-compatible business application data creates a folder, which is required by a specific application system at a prescribed or given timing, based upon data relating to one or a plurality of reports entered using an input terminal. Here a user signifies an employee, etc., of an enterprise or the like who enters a report using an input terminal. In other words, in the sense that the system is one in which input is possible in a form suited to a record or report of actions or activities of a user (i.e., the system is user-compatible), and moreover generates folder data that is data required by an application system (business application), the system is named a system for generating user-compatible business application data.

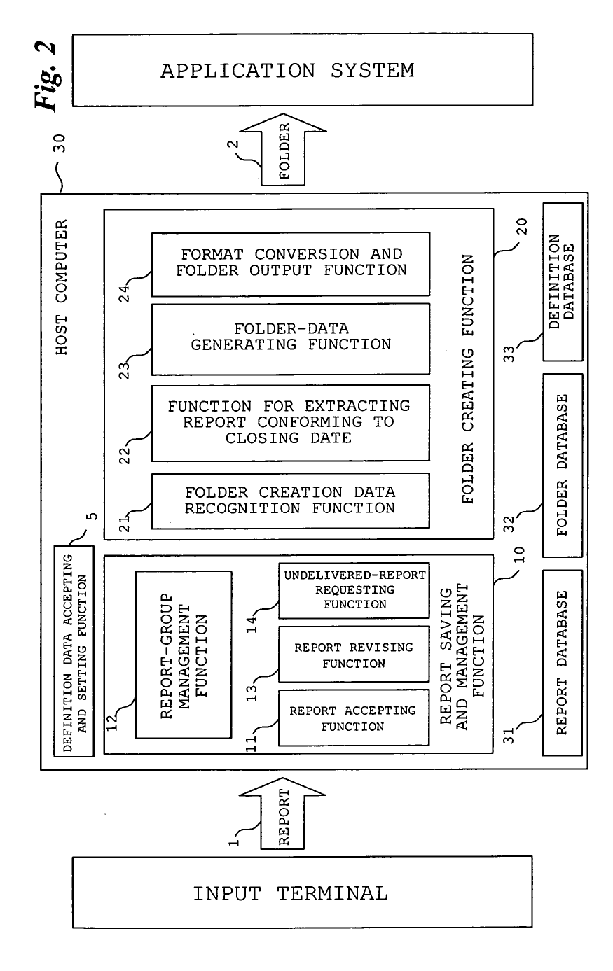

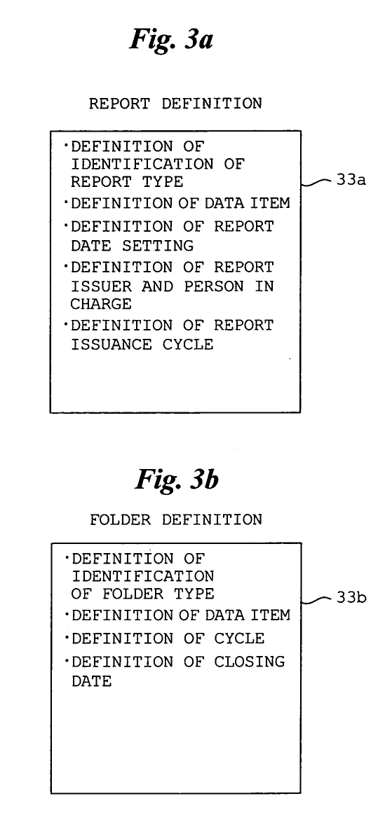

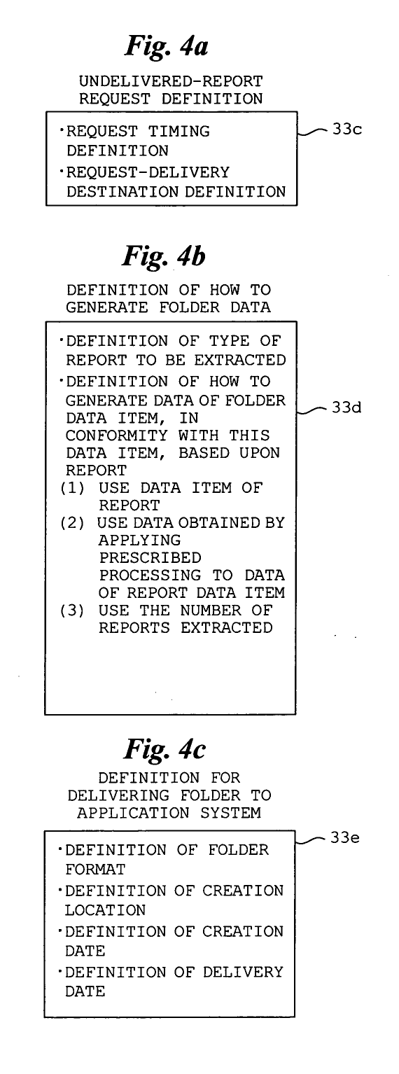

FIG. 2 is a functional block diagram representing processing executed in a system for generating user-compatible business application data, i.e., for generating the data of two folders, which are to be applied to an application system, based upon data relating to one or a plurality of reports 1 entered from an input terminal (input terminals of a variety of types can be utilized, as will be described later). FIGS. 3a to 4c illustrate types of definition data stored in a definition database 33 and content defined in the definition data.

The system for generating user-compatible business application data is implemented based around a host computer 30 having a report database (storage means) 31, a folder database (storage means) 32 and the definition database (storage means) 33. The host computer 30 constitutes a computer system having a CPU for overall control of the host computer 30; an input unit (keyboard, mouse, etc.) for inputting data, instructions and commands; a display unit (a CRT display, etc.) for displaying commands, characters, numerals, symbols and images; a transceiver (modem, etc.) for sending and receiving data to an from other units via a network; a memory for providing a buffer area and work area; and a storage device (hard disk, etc.) for storing a program for generating user-compatible business application data, which functions as the system for generating user-compatible business application data, the report database 31, the folder database 32 and the definition database 33, etc.

If the host computer 30 is viewed from the standpoint of its processing functions (processing means), it is broadly divided into a definition data accepting and setting function (means) (function block 5), a report saving management function (means) (function block 10) and a folder creating function (means) (function block 20).

The definition data accepting and setting function 5 (definition data accepting means, definition data accepting program) 5 is a function for accepting input (setting) of definition data that enters from the input unit with which the host computer 30 is provided and storing the definition data in the definition database 33. The definition data is stored in the definition database 33 by the definition data accepting and setting function 5. The details of the content of definition data stored in the definition database 33 will be described later. The system for generating user-compatible business application data operates based upon the definition data that has been stored in the definition database 33. For example, an input field for each definition is displayed on the display screen of the display unit, and definition data is entered in the definition entry field from a keyboard. The entered definition data is stored in the definition database 33. Processing such as processing for displaying the definition entry field on the display screen, processing for accepting entry of definition data entered using the keyboard, and processing for storing the entered definition data in the definition database 33 is executed by the definition data accepting and setting function 5.

More specifically, the report saving management function 10 includes a report accepting function (means) (function block 11), a report-group management function (means) (function block 12), a report revising function (means) (function block 13) and an undelivered-report requesting function (means) (function block 14). The content of each of these functions is as follows:

Report Accepting Function (Function Block 11):

The report accepting function 11 (report accepting means, part of the report accepting function) is a function for accepting a report that is entered from an input terminal. Report acceptance includes receiving a report, which will be transmitted from the input terminal via a network, at the host computer 30, and reading a report, which has been recorded on a recording medium (flexible disk, etc.), out of the recording medium at the input terminal or host computer 30.

Reports of one or a plurality of types are entered from an input terminal. All reports entered from the input terminal include a code (report name, etc.) for identifying the type of the report, data of a data item included in the report, data representing a date and name of the creator of the report (some of these may constitute the report identification code). In a case where date data is not included in a report entered from an input terminal and accepted by the report-group management function 12, the latter also executes processing for adding the date data to the report received. As a result, a report stored in the report database 31 will always possess a date (time data).

Report-Group Management Function (Function Block 12):

The report-group management function 12 (report-group management means, part of the report accepting program) is a function for managing a report that has been accepted (entered) by the report accepting function 11. This function executes processing such as storing (saving or registering) a new report in the report database 31, deleting an unwanted report from the report database 31, reading a report that has been stored in the report database 31 out of the report database 31, and recovering of data in the report database 31. It may be so arranged that for every report stored in the report database 31, an acceptance code (symbol, number) for identifying each stored report may be appended to the report.

Report Revising Function (Function Block 13):

The report revising function 13 (report revising means) is a function for adding data to or deleting data from a report, which has been stored in the report database 31, and for altering the data. An instruction (command) for addition, deletion, alteration, etc., of data in a report that has been stored in the report database 31 is entered from the input unit of the host computer 30. Of course, it may be so arranged that an instruction (command) for addition, deletion, alteration, etc., of data in a report that has been stored in the report database 31 is entered using a computer (inclusive of an input terminal), which has been connected to the host computer 30 via a network, and the entered instruction is received at the transceiver of the host computer 30. On the basis of an entered or received instruction, a report that has been stored in the report database 31 has its data added to, deleted or altered by the report revising function 13. Further, the report revising function 13 also has a function for storing the history of any addition, deletion or alteration of data in a case where data that has been stored in the report database 31 has been added to, deleted or altered.

Undelivered-Report Requesting Function (Function Block 14):

The undelivered-report requesting function 14 (undelivered-report requesting means, undelivered-report requesting program) is a function which, if a report that should have been stored in the report database 31 has not been stored in the report database 31, is for issuing a request for the report. A report definition 33a (FIG. 3a) stored in the definition database 33 for every type of report possesses, for each report, a definition relating to the issuers and the person in charge of the report and a definition relating to a report issuance cycle. The definition relating to the issuers and the person in charge of the report constitutes the names (generally plural) of employees, etc., who are to input the report using an input terminal and store the report in the report database 31, and the name of the person in charge. A definition relating to a report issuance cycle indicates how a report should be stored in the report database 31 and at what cycle (daily, whenever necessary, etc.). That is, a definition relating to report issuers and person in charge contained in the report definition 33a provided for every type of report specifies, for every type of report, which user is to enter the report, and a definition relating to a report issuance cycle contained in the report definition 33a specifies, for every type of report, the timing (deadline) by which the report is to be entered (this can be construed to be data that specifies a report that should have been stored in the report database 31). In other words, the definition relating to the issuers and person in charge of a report and the definition relating to the report issuance cycle specify who (which user) is to enter which type of report and store it in the report database 31 and by when.

The undelivered-report requesting function 14 searches reports that have been stored in the report database 31 and determines whether a user who is supposed to enter a report specified by the definition relating to the report issuers and person in charge provided for every type of report has entered the report regularly (daily, weekly, biweekly, etc.) as specified by the definition relating to the report issuance cycle. That is, it is determined whether date data possessed by a report that has been stored in the report database 31 is in agreement with the report issuance cycle. If existence of a report that has not yet been stored (namely an undelivered report) is detected regardless of the fact that it should already have been stored in the report database 31, then the undelivered-report requesting function 14 extracts the name of a specific employee, etc., who is supposed to enter the report. On the basis of a request-delivery destination definition (e.g., the e-mail address of a mobile telephone possessed by each employee, etc.) in an undelivered-report request definition 33c (FIG. 4a) in the definition database 33, the undelivered-report requesting function 14 executes processing such as for transmitting text, which requests entry of the report, to the input terminal of a mobile telephone, etc., possessed by an employee, etc., specified by the name detected.

The processing for detecting an undelivered report and the processing for transmitting the requesting text executed by the undelivered-report requesting function 14 is executed at a timing specified by a request-timing definition in the undelivered-report request definition 33c. The request-timing definition stipulates how many days prior to a folder creation date [specified for every type of folder in a definition (FIG. 4c) of folder delivery to an application system] the detection of and request for an undelivered report is to be executed.

Processing based upon the folder creating function (function block 20) is executed based upon data of a report that has been stored in the report database 31.

More specifically, the folder creating function (means) 20 includes a folder creation date recognition function (means) (function block 21), a function (means) (function block 22) for extracting (selecting) a report conforming to a closing date, a folder-data generating function (means) (function block 23) and a format conversion and folder output function (means) (function block 24). The content of each of these functions (means) is as follows:

Folder Creation Data Recognition Function (Function Block 21):

The folder creation date recognition function 21 (start means, start program) is a function for starting folder creation processing (for controlling the host computer 30 so as to start folder creation), based upon a date representing the machine time of the host computer 30, in a case where this date corresponds to the creation date of a folder to be applied to an application system [the creation date is the timing (trigger) of creation of a folder specified for each type of folder in the definition 33e (FIG. 4c), which defines delivery of the folder to the application system, stored in the definition database 33]. More specifically, processing described below is executed, namely processing by the report extracting (selecting) function 22 for a report conforming to the closing date, processing by the folder-data generating function 23 and processing by the format conversion and folder output function 24. Thus, the type of folder to be created is specified by the folder creation date recognition function 21.

Function (Function Block 22) for Extracting (Selecting) Report Conforming to Closing Date:

The function 22 for extracting (selecting) a report conforming to a closing date [namely report extracting (selecting) means or a report extracting (selecting) program] is a function for extracting (selecting), from the report database 31, a report of a type to be used in folder creation and having a date that falls within a prescribed range of dates, the report being selected or extracted from among reports that have been stored in the report database 31. The type of report to be used in folder creation is specified for every type of folder in a definition 33d (FIG. 4b) of how to generate data of a folder stored in the definition database 33. The range of dates of a report to be used in creating a folder is specified, for every type of folder, in a folder definition 33b (FIG. 3b).

Folder-Data Generating Function (Function Block 23):

The folder-data generating function 23 (folder-data generating means, folder-data generating program) is a function for generating data of a data item of a folder, which is to be applied to an application system, using a report that has been extracted by the above-mentioned function 22 for extracting a report conforming to the closing date. A folder applied to an application system contains one or a plurality of data items, and the data of the data items of the folder is generated by the folder-data generating function 23. There are cases where there is a single folder having generated folder data and cases where there are a plurality of such folders. The processing executed by the folder-data generating function 23 is processing whereby the data of a data item in a report is made a corresponding data item of a folder, processing whereby data, which is obtained by applying prescribed processing to data of one or a plurality of data items of a report, is made data of a data item of a folder, and processing whereby the number of extracted reports is made data of a data item of a folder. How folder data is generated is specified for every type of folder and every data item included in a folder in the definition 33d (FIG. 4b) of how to generate data of a folder stored in the definition database 33.

Format Conversion and Folder Output Function (Function Block 24):

The format conversion function is a function for converting data of a folder, which has been generated by the folder-data generating function 23, to a data format required by the application system. The format conversion is executed based upon the definition of the format of a folder in the definition 33e (FIG. 4c), which defines delivery of the folder to the application system, stored in the definition database 33. By virtue of the format conversion, the folder applied to the application system is completed. Further, the folder output function executes processing for saving the completed folder, which is transferred or transmitted to the application system, in a prescribed path (address) of a storage device of the host computer 30.

The definition database 33 (FIGS. 3a to 4c) will now be described. The definition data stored in the definition database 33 is as follows:

Report Definition 33a (FIG. 3a)

The report definition 33a is stored, for every type of report, in the definition database 33. The report definition 33a includes a definition (report-type name or type code, etc.) relating to the type of report, a definition (data item name) relating to a data item contained in the report, a definition relating to setting of the date of the report (e.g., for specifying that the date of entry into the input terminal is the date of the report, or that the date at the time of entry into the host computer 30 is the date of report, etc.), a definition of the report issuers [the names (generally plural) of employees, etc., who are to enter the report] and of the person in charge, and a definition (daily, whenever necessary, etc.) of the report issuance cycle. The definition relating to a data item also includes, for every data item, a definition relating to a data attribute, such as whether the data of the data item is numerical-value data or character data.

Folder Definition 33b (FIG. 3b)

The folder definition 33b is stored, for every type of folder, in the definition database 33. The folder definition 33b includes a definition (folder type name or type code, etc.) relating to the type of folder, a definition relating to a data item contained in the folder, a definition relating to the folder creation cycle (hourly, weekly, biweekly, monthly, etc.), and a definition relating to closing period (terminal points).

A closing period (terminal point) specifies the beginning and end of an interval of a fixed period. For example, the fact that a closing date is the 20^{th} day of every month, or the fact that a closing date is Friday of every week, etc., is defined. If the closing date is the 20^{th} day of every month, then a range of dates from the 21^{st} day of the previous month to the 20^{th} day of the present month is adopted as the period. If the closing date is Friday of every week, then a range of dates corresponding to Saturday of the previous week to Friday of the present week is adopted as the period. The function 22 for extracting a report conforming to the closing date extracts a report, which possesses date data (time data) that falls in a date range specified by the closing date decided by the folder definition 33b, from the report database 31.

Undelivered-Report Request Definition 33c (FIG. 4a)

A report that should have been stored in the report database 31 may not yet have been stored. The undelivered-report request definition 33c in such case is a definition for transmitting text or the like, which requests entry of the report, to the input terminal possessed by an issuer and/or person in charge who is supposed to enter (issue) the report. The undelivered-report request definition 33c is stored for every type of report. The undelivered-report request definition 33c includes a request-timing definition [which stipulates how many days prior to a folder creation date (specified in the definition of folder delivery to an application system, described next) the detection of and request for an undelivered report is to be executed].

Definition 33d (FIG. 4b) of how to Generate Folder Data

The definition 33d of how to generate folder data is decided for every type of folder. A folder is created based upon data relating to one or a plurality of reports, as mentioned above. Definition 33d specifies, for every type of folder, how data of a data item of the folder is generated from data relating to a report of any type. The definition 33d of how to generate folder data includes a definition of the type of report to be used in creating a folder, and data of a data item of the folder is generated using the report of the type specified by the report-type definition. Data relating to a report includes data of the report items, the type of report, the identification code thereof and number of reports, etc. For example, the following definitions are made in conformity with respective ones of folder data items: (1) use of the data of a specific data item of a report as is; (2) use of data obtained by applying prescribed processing (four-rule processing utilizing data of a specific data item and data of another specific item) to data of a specific item of a report; and (3) use of the number of reports extracted by the definition 22 for extracting a report conforming to a closing date.

Definition 33e (FIG. 4c) for Delivering Folder to Application System

The definition 33e for delivering a folder to an application system is decided for every type of folder. The definition for delivering a folder to an application system includes a definition relating to the format of a folder applied to an application system, a definition relating to the location of creation (storage) of a folder (an address or path on a hard disk of the host computer 30), a definition relating to type of medium in a case where the application system reads data out of a medium such as a magnetic tape, a definition (25^{th} day of every month, Monday of every week, etc.) relating to creation date of a folder, and a definition relating to a delivery date (26^{th} day of every month, Tuesday of every week, etc.) for delivery of a created folder to the application system.

Various functions (FIG. 2) of the above-described system (host computer 30) for generating user-compatible business application data are implemented based upon a program stored on a hard disk with which the host computer 30 is provided. A plurality of programs (inclusive of program routines) for implementing respective ones of the various functions may be stored on the hard disk, or a program (inclusive of a program routine) for implementing a plurality of functions may be stored on the hard disk. A program that causes the host computer 30 to implement various functions executes various functions in accordance with the definition data 33a to 33e stored in the definition database 33. Of course, some or all of various functions can also be implemented by hardware processing by providing the host computer 30 with hardware that implements the various functions.

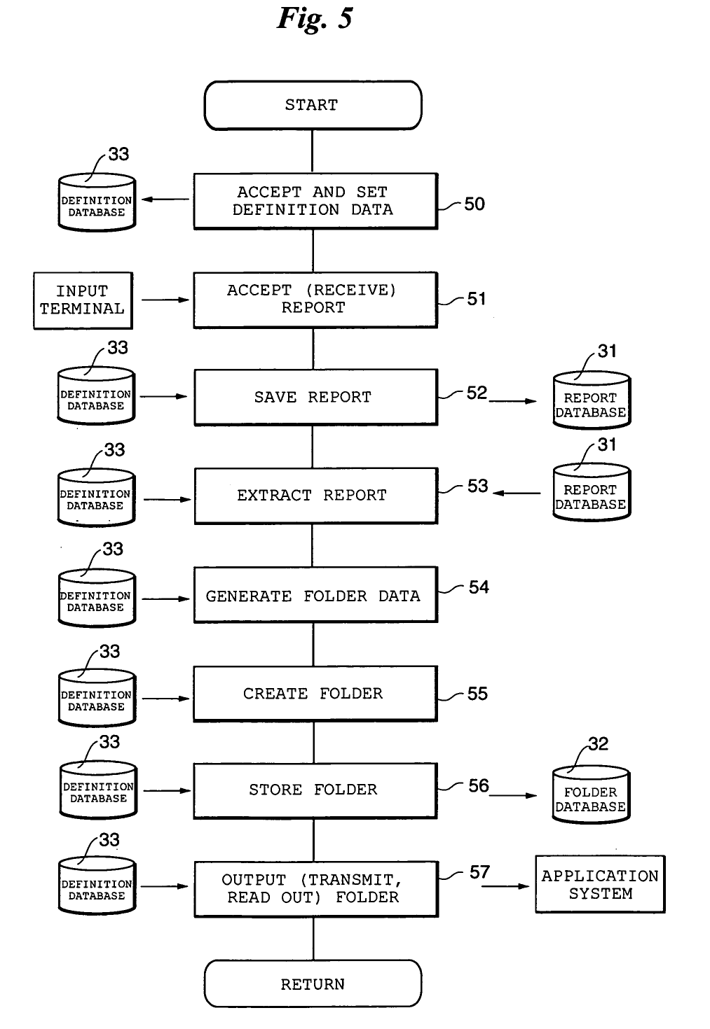

FIG. 5 is a flowchart illustrating the flow of the main processing operation of the system (flow of processing based upon a program) for generating user-compatible business application data according to the present invention. Before specific processing is described, an overview of the main processing operation of the system for generating user-compatible business application data will be described.

Processing for accepting and setting definition data is executed as preliminary preparations for running the system for generating user-compatible business application data (step 50) (this corresponds to the definition data accepting and setting function 5 in the functional block diagram shown in FIG. 2).

The definition data 33a to 33e is registered in the above-described definition database 33 in the processing for accepting and setting definition data. That is, the report definition 33a and undelivered-report request definition 33c are set with regard to each type of report entered from an input terminal. The folder definition 33b, definition 33d of how to generate data of a folder and definition 33e for delivering a folder to an application system are set with regard to each folder that is to be input to the application system. In the processing for accepting and setting definition data, the report definition 33a, folder definition 33b, undelivered-report request definition 33c, definition 33d of how to generate data of a folder and definition 33e for delivering a folder to an application system are set (input) by the administrator, etc., of the host computer 30 using the input unit and display unit of the host computer 30. These set definitions are stored (registered) in the definition database 33.

The report entered from the input terminal is accepted (step 51) (this is processing by the report accepting function 11). In a case where the input terminal and system for generating user-compatible business application data have been connected to each other via a network, a report that has been entered from the input terminal is transmitted from the input unit (as the occasion demands or regularly) and is received (accepted) by the system for generating user-compatible business application data.

The report accepted is stored in the report database 31 (step 52) (this is processing by the report-group management function 12).

In a case where a date represented by the machine time of the host computer 30 is a date (trigger timing) that corresponds to the creation date of a folder contained in the definition 33e, which defines delivery of the folder to the application system, stored in the definition database 33 for every type of folder, creation of the folder of this type starts (this is processing executed by the folder creation date recognition function 21 (the report extracting program and folder-data generating program are started by the start program).

A report of the type to be used in creating a folder specified by the definition 33d of how to generate data of a folder, which report has a date that falls within an interval specified by the definition of the closing date in the folder definition 33b, is extracted (selected) from among reports that have been stored in the report database 31 (step 53) [this is processing by the function for extracting (selecting) a report that conforms to the closing date]. The extracted (selected) report is stored in the report database 31 temporarily.

On the basis of data relating to the extracted report that has been stored in the report database 31, data (folder data) of data items of the folder is generated in accordance with the definition 33d of how to generate data of a folder (step 54) (this is processing by the folder-data generating function 23). The generated folder data undergoes a format conversion to the format required by the folder database 32, whereby the folder is created (step 55). The created folder is stored in the folder database 32 (step 56). By transferring or transmitting a folder, which has been stored in the folder database 32, to an application system (or by having the application system read a folder that has been stored in the folder database 32), the folder is applied to the application system (step 57) (this is processing by the format conversion and folder output function 24).

In the example described above, a report of the type to be used in creating a folder specified by the definition 33d of how to generate data of a folder, which report falls within an interval specified by the folder definition 33b, is extracted (selected) from the report database 31. However, in a case where it is unnecessary to extract a report belonging to a specific interval to be extracted from the report database 31, only a report of the type to be used in creating the folder specified by the definition 33d of how to generate data of a folder may of course be extracted (selected) from the report database 31. In a case where it is unnecessary for a report of a specific type to be extracted from the report database 31, only a report that falls within an interval specified by the folder definition 33b may be extracted (selected) from the report database 31. Further, instead of or in addition to extracting (selecting) a report utilizing the report type and report interval, a report that includes a specific data item can be extracted from the report database 31, or a report that includes a specific data value can be extracted from the report database 31.

Further, instead of starting the report extracting program and folder-data generating program by the start program, the operator may start the report extracting program and folder-data generating program at a given timing.

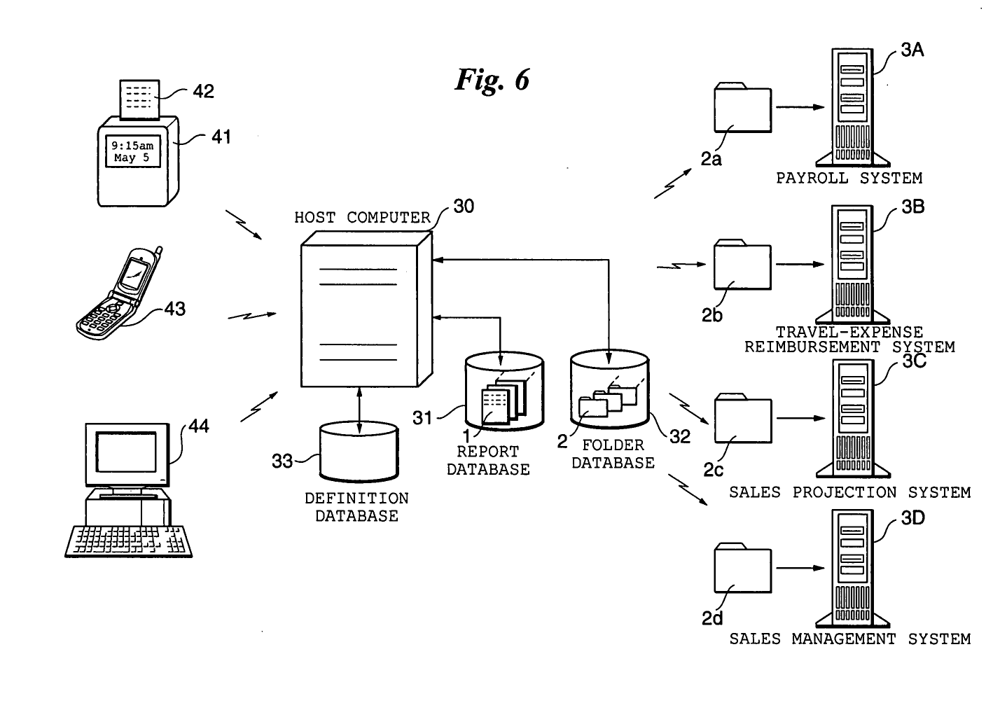

One example of the system (host computer 30) for generating user-compatible business application data will now be described in concrete terms. FIG. 6 illustrates the relationship among input terminals 41, 43, 44, the host computer 30 and application systems 3A to 3D.

A time recorder 41, mobile telephone 43 and personal computer 44 are connected to the host computer 30 via a network (wired or wireless). Further, a payroll system 3A, travel-expense reimbursement system 3B, sales projection system 3C and sales management system 3D are connected to the host computer 30 via a network.

The host computer 30 includes a CPU, an input unit (keyboard, mouse, etc.), a display unit, a communication unit, a memory and a hard disk, etc. The report database 31, folder database 32 and definition database 33 are provided on the hard disk of the host computer 30. As will be described later, various reports 1 that are input from the time recorder 41, mobile telephone 43 and personal computer 44 are stored in the report database 31. Folders 2 generated based upon the reports 1 are stored in the folder database 32. The above-described definition data 32a to 33d is stored in the definition database 33. In a case where various functions (see FIG. 2) executed by the host computer 30 are implemented by a program, the program for executing the various function also is stored on the hard disk of the host computer 30, as mentioned earlier.

The payroll system 3A, travel-expense reimbursement system 3B, sales projection system 3C and sales management system 3D are so-called application systems. The payroll system 3A is a system that calculates the salaries of employees, etc., the travel-expense reimbursement system 3B is a system that reimburses travel expenses and transportation fees that have been paid for by employees, etc., the sales projection system 3C is a system that projects sales of merchandise, etc., and the sales management system 3D calculates the actual sales of the merchandise, etc. A payroll-system folder (referred to as a “salary folder” below) 2a, a folder for the travel-expense reimbursement system (referred to as a “travel-expense reimbursement folder”) 2b, a folder for the sales projection system (referred to as a “sales projection folder” 2c and a folder for the sales management system (referred to as a “sales management folder”) 2d are applied to the payroll system 3A, travel-expense reimbursement system 3B, sales projection system 3C and sales management system 3D, respectively. These application systems operated based upon respective ones of the folders applied thereto.

When an employee arrives at work and leaves work, the punch-in time and punch-out time of the employee are punched in a timecard 42 together with the date. The punch-in times and punch-out times of employees punched by the time recorder 41 are stored temporarily together with data representing codes (e.g., employee names) for identifying the employees and data representing the date, after which, or as the occasion demands, these are transmitted to the host computer 30. Data applied from the time recorder 41 to the host computer 30 shall be referred to as a “timecard report 1a”. Of course, it may be so arranged that a date and time that have been punched in the timecard 42 are input together with an employee name, etc., using a data-input computer separate from the time recorder 41, and the data that has been input to the data-input computer is transmitted to the host computer 30.

In a case where an employee, etc., has visited a customer, the employee creates a user-visitation report that includes the employee's own name, the date of the visit and the name of the user visited, etc. (this data is input using the mobile telephone 43 or personal computer 44). Further, in a case where the employee has visited a customer directly without punching in at his company, or in a case where the employee has been on paid leave, the employee creates a job notification in which the date of the duty and the reason for submission of the notification, etc., are written (this data is input using the mobile telephone 43 or personal computer 44). The data based upon user-visitation report entered from the mobile telephone 43 or personal computer 44 shall be referred to as a “user-visitation report 1b”, and the data based upon the job notification entered from the mobile telephone 43 or personal computer 44 shall be referred to as a “notification report 1c”. The user-visitation report 1b and the notification report 1c are transmitted from the mobile telephone 43 or the personal computer 44 to the host computer 30.

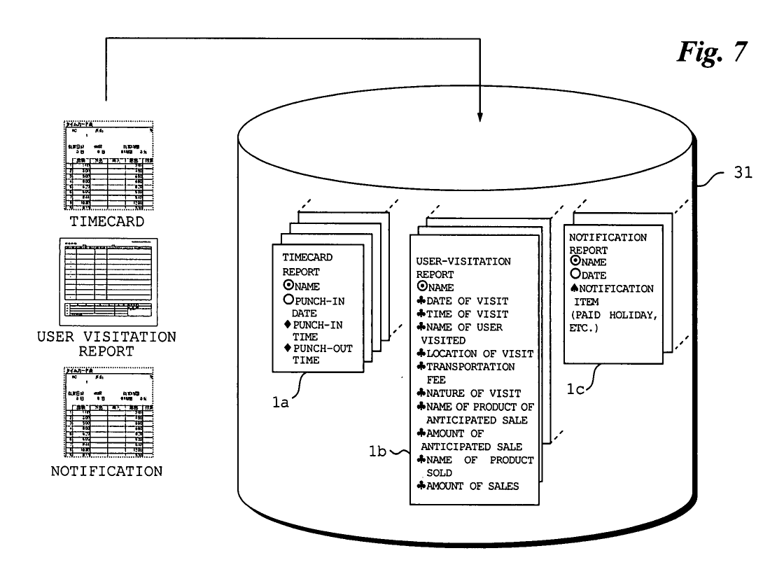

FIG. 7 illustrates the content of the report database 31.

The timecard report 1a transmitted from the time recorder 41 to the host computer 30, and the user-visitation report 1b and notification report 1c transmitted from the mobile telephone 43 or personal computer 44 to the host computer 30 are received by the transceiver of the host computer 30. The timecard report 1a, user-visitation report 1b and notification report 1c received are stored (accumulated) in the report database 31 of the host computer 30 (this is processing executed by the report accepting function 11 and report-group management function 12). The reports 1a to 1c stored in the report database 31 all include a report creation date or creation time (the execution date or execution time of the job, etc.) and the name of the report creator, etc.

The reports 1a to 1c stored in the report database 31 can be revised by an employee or the like (the person making the revision may be limited to the employee, e.g., having the right to do so) (this is processing executed by the report revising function 13). In this case, the revised reports 1a, 1b, 1c are stored in the report database 31.

As will be described next, the salary folder 2a, travel-expense reimbursement folder 2b, sales projection folder 2c and sales management folder 2d are created based upon the timecard report 1a, user-visitation report 1b and arrival/departure report 1c that have been stored in the report database 31.

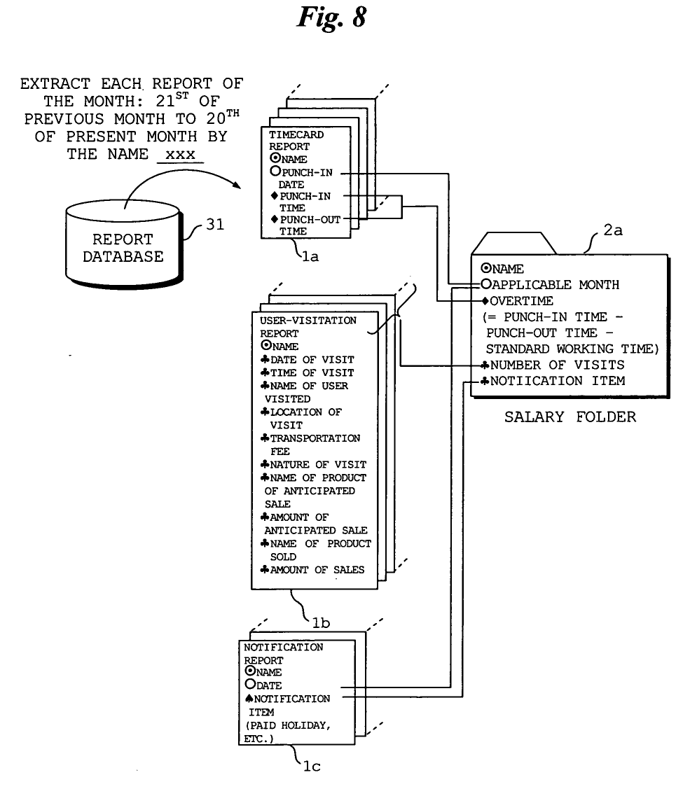

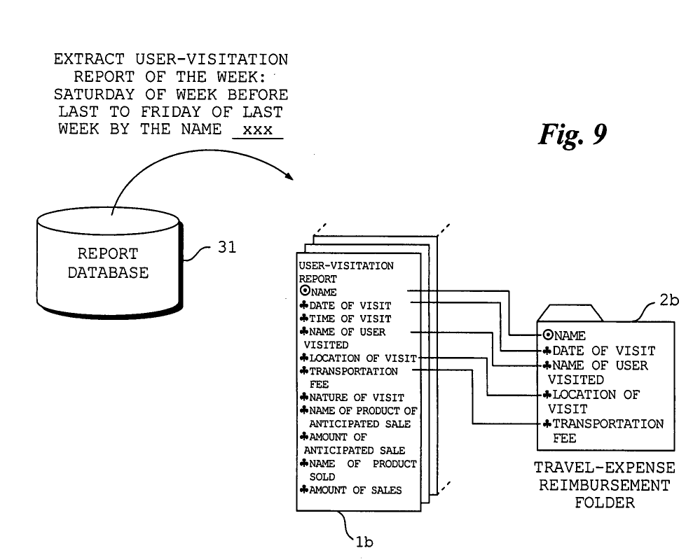

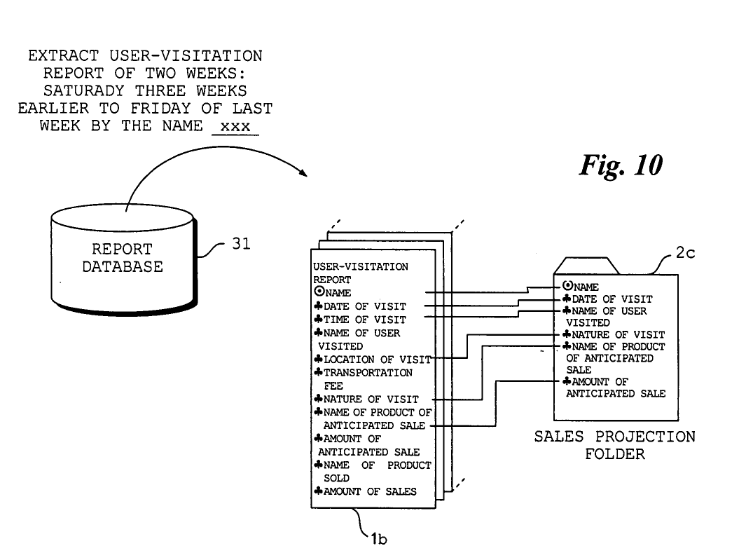

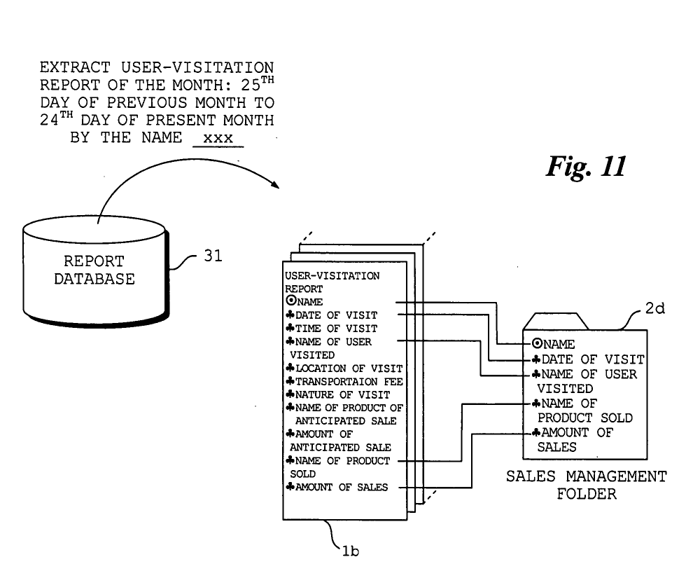

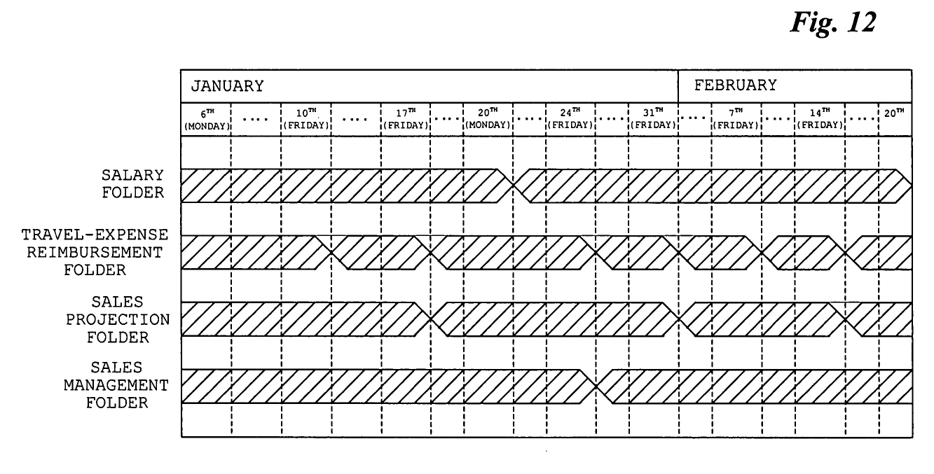

FIG. 8 illustrates the manner in which the salary folder 2a is created, FIG. 9 the manner in which the travel-expense reimbursement folder 2b is created, FIG. 10 the manner in which the sales projection folder 2c is created and FIG. 11 the manner in which the sales management folder 2d is created. FIG. 12 illustrates ranges of dates (closing dates) of reports used in creating the salary folder 2a, travel-expense reimbursement folder 2b, sales projection folder 2c and sales management folder 2d.

The creation timings of the salary folder 2a, travel-expense reimbursement folder 2b, sales projection folder 2c and the sales management folder 2d have been defined [definition of creation dates contained in the definition 33e (FIG. 4c) for delivering a folder to an application system]. For example, assume that creation of the salary folder 2a on the 21^{st} day of every month has been defined. If it is judged based upon the machine time of the host computer 30 that the date of the present day is the 21^{st} day, the creation of the salary folder 2a is started by the host computer 30 (this is processing by the folder creation date recognition function 21). Of course, if creation starting time is defined beforehand together with the folder creation date in the definition of creation date regarding the salary folder 2a, then the creation of the salary folder 2a will start at a prescribed timing on the 21^{st} day.

Reference will be had to FIGS. 8 and 12. Assume that the salary folder 2a has a closing date of the 20^{th} day of every month [the cycle and closing date are described in the report definition 33a (FIG. 3a)]. Further, assume that a timecard report, user-visitation report and notification report have been defined, as the names of types of reports to be extracted, in the definition 33d of how to generate data of a folder (FIG. 4b). In this case, the timecard report 1a, user-visitation report 1b and notification report 1c, which have date data indicative of a period from the 21^{st} day of the previous month to the 20^{th} day of the present month, regarding a certain employee or the like are extracted from the report database 31 and stored in the memory of the host computer 30 (this is processing executed by the function 22 for extracting a report that conforms to a closing date).

On the basis of the definition 33d (FIG. 4b) of how to generate data of a folder, the data of data items [defined by the folder definition 33b (FIG. 3b)] of the salary folder 2a is generated based upon the extracted timecard report 1a, user-visitation report 1b and notification report 1c (this processing is executed by the folder-data generating function 23).

For example, assume that the salary folder 2a has five data items, namely a person's name, the applicable month (which indicates the particular month for which salary has been calculated in the salary report), overtime, number of visits and notification item. The host computer 30 (folder-data generating function 23) generates data of each data item of the salary folder 2a as follows based upon the definition 33d of how to generate data of a folder:

Name: The person's name in the extracted timecard report 1a or person's name in the extracted notification report 1c is adopted as the name of the salary folder 2a.

Applicable month: The older month included in the date (day, month, year) of the extracted timecard report 1a or in the date (day, month, year) of the extracted notification report 1c (e.g., if the timecard report 1a or notification report 1c has dates from January 21^{st} to February 20^{th}, then the older month in January) is adopted as the applicable month.

Overtime: Assume that a time that is the result of calculating on-duty time by subtracting punch-out time from punch-in time in the timecard report 1a and then subtracting standard working time from the calculated on-duty time is the overtime for one day. The overtime for the period from the 21^{st} of the previous month to the 20^{th} of the present month is summed and the total is adopted as the overtime for one month.

Number of visits: The number of extracted user-visitation reports 1b is adopted as the number of visits.

Notification item: The reason for the notification in the notification report 1c (the reason why the timecard 42 was not punched on the day the employee should have punched in, e.g., paid leave, direct travel to and from the customer location, etc.) is adopted as is as the notification item of the salary folder 2a. In the notification report 1c, the reason for the notification is specified by a code representing a candidate that has been selected from several selection candidates. The code representing the reason for the notification is used in the salary folder 2a as well.

Thus, data relating to the name of the person, the applicable month, overtime, number of visits and notification item is obtained. If the data obtained is converted to a prescribed data format required by the payroll system 3A, the salary folder 2a is completed. The completed salary folder 2a is stored in the folder database 32 (this is processing executed by the format conversion and folder output function 24).

The salary folder 2a is transferred or transmitted to the payroll system 3A on the delivery date in accordance with the delivery-date definition in the salary folder 2a defined in the definition 33e (FIG. 4c) for delivering a folder to an application system. If the specifications of the payroll system 3A are such that the salary folder 2a is to be read in from the folder database 32 of the host computer 30 in which it has been stored, then the payroll system 3A reads the salary folder 2a out of the folder database 32 in accordance with the definition of the creation location (path) of the salary folder 2a in the definition 33e (FIG. 4c) for delivering a folder to an application system. In a case where the specifications of the payroll system 3A are such that the salary folder 2a is to be read in from a medium such as magnetic tape, the created salary folder 2a is recorded on a medium corresponding to the data input (read-in) unit of the payroll system 3A [e.g., if the input (read-in) unit of the payroll system 3A is a magnetic-tape read-in unit, then the medium is magnetic tape]. The medium on which the salary folder 2a has been recorded is set in the input unit of the payroll system 3A, whereby the salary folder 2a is applied to the payroll system 3A.

With the payroll system 3A, processing for calculating salary is executed based upon the content of the salary folder 2a. For example, the amount of basic salary for one month, an amount obtained by multiplying overtime by a prescribed figure and an amount obtained by multiplying number of visits by a prescribed figure are added and, if the notification item is not reasonable, a prescribed figure is subtracted. Thus, the amount of one month's salary regarding a specific employee or the like is calculated.

The salary folder 2a is created by similar processing with regard to other employees as well and one month's salary is decided for these employees in the payroll system 3A.

Of course, in a case where the user-visitation report 1b or notification report 1c has not been extracted (i.e., in case of an employee for which a user-visitation report or notification report has not been created in the period from the 21^{st} day of the previous month to the 20^{th} day of the present month), the salary folder 2a would be created from the timecard report 1a alone.

Creation of the travel-expense reimbursement folder 2b, sales projection folder 2c and sales management folder 2d will now be described in brief.

With reference to FIGS. 9 and 12, the travel-expense reimbursement folder 2b is such that Friday of every week is the closing date. (Calendar data has been stored on the hard disk, etc. of the host computer 30, and the host computer 30 recognizes the data corresponding to the day of the week based upon the calendar data). Creation of the travel-expense reimbursement folder 2b is performed on Monday of every week. Creation of the travel-expense reimbursement folder 2b is started by the host computer 30 on Monday of every week.

A user-visitation report 1b having a date from a date corresponding to Saturday of the week before last to a date corresponding to Friday of last week is extracted from the report database 31. The travel-expense reimbursement folder 2b is created upon extracting data, which represents the name of a person, date of a visit, name of the user visited, location of the visit and transportation fees, from the data contained in the user-visitation report 1b extracted. The travel-expense reimbursement folder 2b is applied to the travel-expense reimbursement system 3B. Based upon data representing transportation fees in the travel-expense reimbursement system 3B, one week's worth of transportation fees to be reimbursed to a specific employee or the like is calculated.

With reference to FIGS. 10 and 12, the sales projection folder 2c is such that Friday of every second week is the closing date.

A user-visitation report 1b having a date from a date corresponding to Saturday three weeks earlier to a date corresponding to Friday of last week is extracted from the report database 31. The sales projection folder 2c is created upon extracting data, which represents the name of a person, date of a visit, name of the user visited, nature of the visit, name of the product for which sale is anticipated and the monetary amount of the anticipated sale, from the data contained in the user-visitation report 1b extracted. The sales projection folder 2c is applied to the sales projection system 3C. A graph or the like indicating a sales projection (a list of two week's worth of product names for which sales are anticipated and monetary amounts of the anticipated sales, and the total of the monetary amount of anticipated sales) with regard to a specific employee or the like is created in the sales projection system 3C.

With reference to FIGS. 11 and 12, the sales management folder 2d is such that the 24^{th} day of every month is the closing date. The creation of the sales management folder 2d is performed on the 25^{th} day of every month.

A user-visitation report 1b having dates from the 25^{th} day of the previous month to the 24^{th} day of the present month is extracted from the report database 31. The sales management folder 2d is created upon extracting data, which represents the name of a person, date of a visit, name of the user visited, name of the sales product and monetary amount of sale, from the data contained in the user-visitation report 1b. The sales management folder 2d is applied to the sales management system 3D. A graph or the like indicating sales performance with regard to a specific employee or the like is created in the sales management system 3D.

In the examples cited above, the salary folder 2a is created on the 21^{st} day of every month, the travel-expense reimbursement folder 2b on Monday of every week, the sales projection folder 2c on Monday of every second week, and the sales management folder 2d on the 25^{th} day of every month. However, it may be so arranged that if the creation date falls on a holiday, then the folder is created on the day after.

The user-visitation report 1b entered by the employee or the like is used in common in the creation of the salary folder 2a, travel-expense reimbursement folder 2b, sales projection folder 2c and sales management folder 2d. That is, it is not necessary to input the user-visitation report 1b (or part of the content of the user-visitation report 1b) for each and every application system (folder). This alleviates the task of entering overlapping data.

Further, the timecard report 1a, user-visitation report 1b and notification report 1c are stored in the report database 31 of the host computer 30 and are read out of the report database 31 in accordance with the folder creation date. It is also unnecessary to input the data of a report in conformity with the launch schedule of an application system.

Furthermore, processing for creating the data of a folder from a report is executed based upon a definition (FIG. 4b) specifying how the data of the folder is to be generated. By revising the definition, the manner in which the folder data is generated can be altered in flexible fashion. Since the relationship between the input terminal and application system is not fixed, it is possible to deal flexibly with a change, increase or decrease in types of input terminals or with an increase or decrease in types of application systems.

As many apparently widely different embodiments of the present invention can be made without departing from the spirit and scope thereof, it is to be understood that the invention is not limited to the specific embodiments thereof except as defined in the appended claims.

What is claimed is:

1. A method of generating user-compatible business application data, the method generating a folder for input to an application system and that is to be applied to the application system at a timing that satisfies a requirement of the application system, the folder having data items and a format required by the application system in order for business processing to be executed by the application system, the folder being generated from an input report having data items and a format that reflect activities of a user and being created at a timing that reflects the activities of the user, said input report being independent, in terms of data items, format and input timing, of data items, format and input timing required by said application system, said method comprising the steps of:
entering an input report, which is accompanied by time-related data, together with an identification code thereof to a generating system, said input report including data regarding one or a plurality of items and having a format suitable for expressing results of user activities;
storing the entered input report together with the identification code thereof in a database of said generating system in order to make said input report available for use in one or a plurality of application systems; and
generating a folder, which includes data required by said application system in a format required by said application system, at a given timing prior to start of business processing in said application system, by selection or manipulation of the input report that has been stored in said database and of data contained in said input report without executing said business processing, and delivering the generated folder to said application system.

2. The method according to claim 1, further comprising the step of generating said input folder by selection or manipulation of an input report, which has been stored in said database, and of data contained in said input report in accordance with a folder generating definition that specifies how said folder is generated from said input report.

3. The method according to claim 1, further comprising the steps of:
selecting an input report to be used in generating said folder from among input reports that have been stored in said database; and
generating said input folder by selection or manipulation of data contained in the selected input report in accordance with a folder generating definition that specifies how said folder is generated from said input report.

4. The method according to claim 3, wherein said report selecting definition includes a report interval definition that specifies the interval of a report to be used in generating said folder, and an input report that falls within an interval to be used in generating said folder is selected, based upon time-related data accompanying an input report that has been stored in said database, in accordance with said report interval definition.

5. The method according to claim 3 or 4, wherein the identification code of said input report includes a code that identifies the type of input report; and
said report selecting definition includes a report-type definition that specifies the type of a report to be used in generating a folder, and an input report of the type to be used in generating said folder is selected, based upon the identification code of the input report that has been stored in said database, in accordance with said report-type definition.

6. The method according to any one of claims 3 to 5, wherein said report selecting definition includes a report item definition that specifies a data item that is to be included in a report to be used in generating said folder, and an input report to be used in generating said folder is selected, based upon a data item included in the input report that has been stored in the database, in accordance with said report item definition.

7. The method according to any one of claims 3 to 6, wherein said report selecting definition includes a data value definition that specifies a data value that is to be included in a report to be used in generating said folder, and an input report to be used in generating said folder is selected, based upon a data value included in an input report that has been stored in the database, in accordance with said data value definition.

8. The method according to any one of claims 1 to 7, wherein the identification code of said input report includes a user identification code that identifies a user who has performed an activity; and
said folder is generated on a per-user basis based upon said user identification code.

9. A program for generating user-compatible business application data, comprising computer code for implementing the steps of:
accepting entry of an input report, which is accompanied by time-related data, together with input of an identification code thereof, to a generating system, said input report including data regarding one or a plurality of items and having a format suitable for expressing results of user activities;
storing the entered input report together with the identification code thereof in a database of said generating system in order to make said input report available for use in one or a plurality of application systems; and
controlling said generating system so as to generate a folder, which includes data required by said application system in a format required by said application system, at a given timing prior to start of business processing in said application system, by selection or manipulation of an input report that has been stored in said database and of data contained in said input report without executing said business processing, and deliver the generated folder to said application system.

10. A system for generating user-compatible business application data, comprising:
input report accepting means for accepting entry of an input report, which is accompanied by time-related data, together with an identification code thereof, the input report including data regarding one or a plurality of items and having a format suitable for expressing results of user activities;
database control means for controlling a database so as to store the input report, which has been accepted by said input report accepting means, together with the identification code thereof in said database in order to make the input report available for use in one or a plurality of application systems; and
folder generating/delivering means for generating a folder, which includes data required by the application system in a format required by the application system, at a given timing prior to start of business processing in the application system, by selection or manipulation of an input report that has been stored in the database and of data contained in the input report without executing the business processing, and delivering the generated folder to the application system.

11. A program for generating user-compatible business application data, comprising:
a definition accepting program for controlling a computer so as to accept, and store in definition data storage means with regard to a folder to be applied to an application system, a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report;
a report accepting program for controlling the computer so as to accept, and store in report storage means, a report having time data, a report-type code and data of one or a plurality of report data items;
a report selecting program for controlling the computer so as to select, from among reports stored in said report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and
a folder data generating program for controlling the computer based upon data relating to the selected report so as to generate data of a data item of a folder, which has been specified by the folder data-item definition, in accordance with the folder data generating definition.

12. A program for generating user-compatible business application data, said program causing a computer to function as:
definition data storage means for storing definition data that includes, with regard to a folder to be applied to an application system, a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report;
report storage means for storing a report having time data, a report-type code and data of one or a plurality of report data items;
report selecting means for selecting, from among reports stored in said report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and
folder data generating means for generating data of a data item of a folder, which has been specified by the folder data-item definition, in accordance with the folder data generating definition based upon data relating to the report by said report selecting means.

13. The program according to claim 11 or 12, wherein the report selecting definition includes a data value to be included in a report to be used in creating a folder; and
a report, which is in line with at least any one condition, is selected from among a report in line with a condition that time data falls within an interval specified by the report selecting definition, a report in line with a condition that the report possesses a report-type code of a type specified by the report selecting definition, a report in line with a condition that the report possesses data of a report data item specified by the report selecting definition, and a report in line with a condition that the report possesses a data value specified by the report selecting definition.

14. The program according to claim 11 or 12, wherein there is selected a report having time data that falls within an interval specified by the report selecting definition, a report-type code of a type specified by the report selecting definition, and data of a report data item specified by the report selecting definition.

15. The program according to claim 13, wherein there is selected a report having time data that falls within an interval specified by the report selecting definition, a report-type code of a type specified by the report selecting definition, data of a report data item specified by the report selecting definition, and a data value specified by the report selecting definition.

16. A definition accepting program for controlling a computer so as to:
accept input of the following definitions from an input unit, with regard to a folder to be applied to an application system:
a folder data-item definition that specifies a data item contained in the folder;
a report selecting definition that specifies an interval of a report to be used in creating a folder, type of report to be used in creating a folder and a report data item that is to be included in a report to be used in creating a folder; and
a folder data generating definition that specifies how data of a data item of a folder is generated from data relating to a report; and
store the accepted folder data-item definition, report selecting definition and folder data generating defining in definition data storage means.

17. A program for generating user-compatible business application data, comprising:
a report selecting program for controlling a computer to select, from among reports, which have been stored in report storage means, having time data, report-type codes and data of one or a plurality of report data items, a report, which is in line with at least any one condition, from among a report in line with a condition that time data falls within an interval of a report to be used in creating a folder specified by the report selecting definition, a report in line with a condition that the report possesses a report-type code to be used in creating a folder specified by the report selecting definition, and a report in line with a condition that the report possesses data of a report data item to be used in creating a folder specified by the report selecting definition; and
a folder data generating program for controlling the computer based upon data relating to the selected report so as to generate data of a data item of a folder, which has been specified by the folder data-item definition, in accordance with a folder data generating definition that specifies how the data of the data item is generated from the data relating to the report.

18. The program according to claim 11 or 12, wherein said folder data-item definition specifies a plurality of data items included on one folder; and
said folder data generating definition specifies how each item of data of the plurality of data items included in said one folder is generated from data relating to a report.

19. The program according to claim 11 or 12, wherein said folder data generating definition includes a definition that specifies that data of a data item contained in report is data of a corresponding data item of a folder.

20. The program according to claim 11 or 12, wherein said folder data generating definition includes a definition that specifies that data, which is obtained by applying prescribed processing to data of one or a plurality of data items contained in a report, is data of a data item of a folder.

21. The program according to claim 11 or 12, wherein said folder data generating definition includes a definition that specifies that the number of reports selected is data of a data item of a folder.

22. The program according to claim 11, wherein said definition accepting program controls the computer so as to further store, in said definition data storage means, a folder-data generating trigger definition that specifies timing for generating data of a data item of a folder to be applied to an application system;
further comprising a program for controlling the computer so as to start said report selecting program and folder data generating program at a timing that has been specified in said folder-data generating trigger definition.

23. The program according to claim 11, wherein said definition accepting program controls the computer so as to further store, in said definition data storage means, a report input deadline definition that specifies an input deadline of a report to be stored in said report storage means;
further comprising a report requesting program for controlling the computer in such a manner that at a timing earlier than a timing specified in said folder-data generating trigger definition, it is determined whether a report, which possesses time data that falls within an interval specified by said report selecting definition, has been stored in said report storage means by a deadline specified by said report input deadline definition, and if it is determined that the report has not been stored in said report storage means by the deadline specified by said report input deadline definition, data representing the fact that this report is to be stored in said report storage means is output.

24. The program according to claim 11, wherein said definition accepting program controls the computer so as to further store, in said definition data storage means, a folder data-item definition, report selecting definition and folder data generating definition with regard to each folder of a plurality of types.

25. A recording medium on which has been recorded a program set forth in any one of claims 11 to 24.

26. The program according to claim 17, wherein said report selecting program and said folder data generating program control a computer having:
definition data storage means for storing, with regard to a folder to be applied to an application system, said folder data-item definition that specifies a data item included in the folder; said report selecting definition that specifies an interval of a report to be used in creating the folder, type of report to be used in creating the folder, a report data item that is to be included in a report to be used in creating the folder, and a data value to be included in a report used in creating the folder; and said folder data generating definition that specifies how data of a data item of a folder is generated from data relating to a report; and
report storage means for storing a report having time data, a report-type code and data of one or a plurality of report data items.

27. A recording medium on which the following programs have been recorded:
a definition accepting program for controlling a computer so as to accept, and store in definition data storage means with regard to a folder to be applied to an application system, a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report;
a report accepting program for controlling the computer so as to accept, and store in report storage means, a report having time data, a report-type code and data of one or a plurality of report data items;
a report selecting program for controlling the computer so as to select, from among reports stored in said report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and
a folder data generating program for controlling the computer based upon data relating to the selected report so as to generate data of a data item of a folder, which has been specified by the folder data-item definition, in accordance with the folder data generating definition.

28. A system for generating user-compatible business application data, comprising:
definition data storage means for storing definition data that includes, with regard to a folder to be applied to an application system, a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report;
report storage means for storing a report having time data, a report-type code and data of one or a plurality of report data items;
report selecting means for selecting, from among reports stored in said report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and
folder data generating means for generating data of a data item of a folder, which has been specified by the folder data-item definition, in accordance with the folder data generating definition based upon data relating to the report by said report selecting means.

29. A method of generating user-compatible business application data, comprising the steps of:
providing definition data storage means and report storage means, said definition data storage means storing, with regard to a folder to be applied to an application system, definition data that includes a folder data-item definition that specifies a data item contained in the folder, a report selecting definition that specifies an interval of a report to be used in creating a folder, type of report to be used in creating a folder and a report data item that is to be included in a report to be used in creating a folder, and a folder data generating definition that specifies how data of a data item of a folder is generated from data relating to a report; and said report storage means storing a report having time data, a report-type code and data of one or a plurality of report data items;
selecting, from among reports stored in said report storage means, a report, which is in line with at least any one condition, from among a report in line with a condition that time data falls within an interval specified by the report selecting definition, a report in line with a condition that the report possesses a report-type code of a type specified by the report selecting definition, and a report in line with a condition that the report possesses data of a report data item specified by the report selecting definition; and
generating data of a data item of a folder, which has been specified by the folder data-item definition, in accordance with the folder data generating definition, based upon data relating to the selected report.
